(19) United States
(12) Patent Application Publication
(10) Pub. No.: US 2021/0340893 A1
(43) Pub. Date: Nov. 4, 2021

(54) BLOW-BY GAS RECIRCULATION DEVICE FOR INTERNAL COMBUSTION ENGINE

(71) Applicant: ISUZU MOTORS LIMITED, Tokyo (JP)

(72) Inventor: Hideki OSADA, Fujisawa-shi, Kanagawa (JP)

(21) Appl. No.: 17/259,768

(22) PCT Filed: Jun. 19, 2019
(86) PCT No.: PCT/JP2019/024311

§ 371 Date: Jan. 12, 2021

(30) Foreign Application Priority Data
Jul. 12, 2018 (JP) 2018-132235

(51) Int. Cl. F01M 13/04; F02M 35/10; B01D 46/24; B01D 46/00; B01D 53/04

(52) U.S. Cl. CPC F01M 13/04; F02M 35/10222; B01D 46/24; B01D 2257/70; B01D 53/0407; B01D 2259/4566; B01D 46/0031

(57) ABSTRACT

A blow-by gas recirculation device includes: a blow-by gas passage connected to an intake passage; an oil separator provided in the blow-by gas passage; and an adsorption/desorption member which is provided in the intake passage and/or the blow-by gas passage. The intake passage and the blow-by gas passage is located between the oil separator and the compressor of a turbocharger, and the adsorption/desorption member is configured so as to adsorb oil contained in a blow-by gas B and desorb the oil while the diameter of particles of the oil is increased.

### TECHNICAL FIELD

The present disclosure relates to a blow-by gas recirculation device for an internal combustion engine, and in particular, to a blow-by gas recirculation device for a turbocharged internal combustion engine.

### BACKGROUND ART

A blow-by gas recirculation device for circulating a blow-by gas, leaked into a crankcase from a gap between a piston and a cylinder, in an intake passage lias been publicly known. A turbocharged internal combustion engine including a compressor of a turbocharger in an intake passage has also been known.

### CITATION LIST

### Patent Literature

Patent Literature 1: JP-A-2014-238032

### SUMMARY OF INVENTION

### Technical Problem

A blow-by gas passage for circulating a blow-by gas may be connected to a position on an upstream side of a compressor in an intake passage. In this case, oil mixed in the blow-by gas is also circulated in the intake passage, and caulking abnormality may occur in the compressor due to the oil.

Further, oil having a large particle diameter of the oil mixed in the blow-by gas is mainly separated by an oil separator provided in the blow-by gas passage, but oil having a small particle diameter thereof is not separated by the oil separator and mainly passes therethrough. Then, since the oil having a small particle diameter tends to be thermally denatured by heat of the compressor as compared with the oil having a large particle diameter, the caulking abnormality is likely to occur.

Therefore, the present disclosure has been made in view of such circumstances, and an object thereof is to provide a blow-by gas recirculation device for an internal combustion engine, by which caulking abnormality of a compressor due to oil contained in a blow-by gas that has passed through an oil separator can be prevented.

### Solution to Problem

According to one aspect of the present disclosure, there is provided a blow-by gas recirculation device for an internal combustion engine that includes an intake passage and a compressor of a turbocharger provided in the intake passage. The blow-by gas recirculation device includes: a blow-by gas passage that is connected to the intake passage at a position on an upstream side of the compressor; an oil separator, provided in the blow-by gas passage, for separating oil from a blow-by gas; and an adsorption/desorption member that is provided in at least one of the blow-by gas passage and the intake passage located between the oil separator and the compressor, and that is configured to adsorb oil contained in a blow-by gas that has passed through the oil separator and expand a particle diameter of the oil to desorb the oil.

It is preferable that the intake passage includes a connection portion to which the blow-by gas passage is connected, and the adsorption/desorption member is provided on an inner circumferential surface of the connection portion that is located on a side opposite to a blow-by gas passage side.

It is preferable that a bent portion is formed on at least one of the intake passage and the blow-by gas passage, and the adsorption/desorption member is provided on an inner circumferential surface on an outer corner side of the bent portion.

It is preferable that the adsorption/desorption member is formed of a nonwoven fabric.

### Advantageous Effects of Invention

According to the present disclosure, it is possible to prevent caulking abnormality of a compressor due to oil contained in a blow-by gas that has passed through an oil separator.

### BRIEF DESCRIPTION OF DRAWINGS

FIG. 1 is a schematic diagram showing a configuration of an embodiment.

FIG. 2 is a sectional view taken along a line II-II of FIG. 1.

FIG. 3 is a graph showing an operation and an effect of the embodiment.

FIG. 4 is a schematic diagram showing a first modification.

FIG. 5 is a schematic diagram showing a second modification.

FIG. 6 is a schematic diagram showing a third modification.

### DESCRIPTION OF EMBODIMENTS

Embodiments of the present disclosure will be described below with reference to the accompanying drawings. It should be noted that the present disclosure is not limned to the following embodiments.

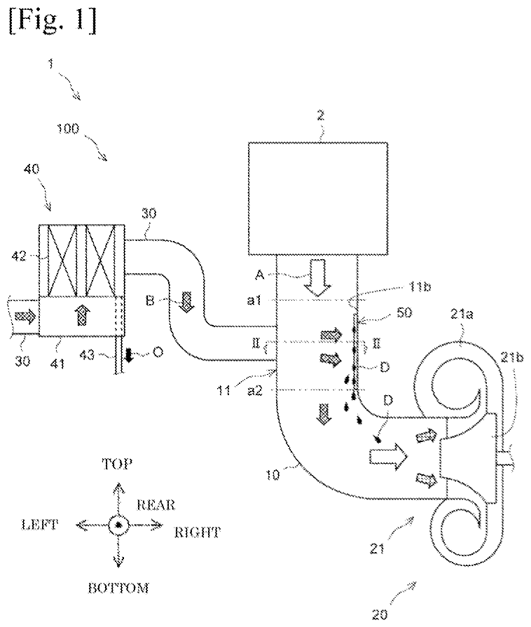

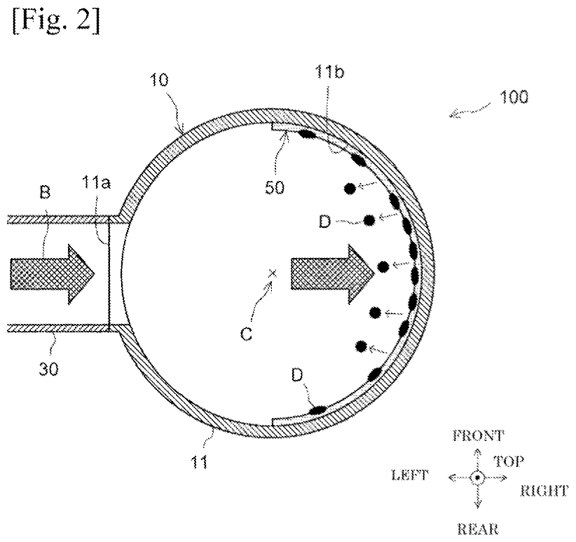

FIG. 1 is a schematic diagram showing a configuration of an embodiment of the present disclosure. In addition, FIG. 2 is a sectional view taken along a line II-II of FIG. 1. In these drawings, white arrows A indicate a flow of intake air of an internal combustion engine 1, and shaded arrows B indicate a flow of a blow-by gas of the internal combustion engine 1. Note that the upper, lower, left, and right directions shown in these drawings are merely defined for convenience of description.

As shown in FIG. 1, the internal combustion engine 1 is a multi-cylinder compression-ignition internal combustion engine, i.e., a diesel engine, mounted on a vehicle (not shown). The vehicle is a large vehicle such as a truck. However, a type, a form, an application, and the like of the vehicle and the internal combustion engine 1 are not particularly limited, and for example, the vehicle may be a small vehicle such as a passenger car, or the internal combustion engine 1 may be a spark-ignition internal combustion engine, i.e., a gasoline engine.

The internal combustion engine 1 includes an intake pipe 10 as an intake passage and a compressor 21 of a turbocharger 20 provided at the intake pipe 10. Note that the internal combustion engine 1 includes an engine body (not shown) and an exhaust system component such as an exhaust pipe (not shown), and a description thereof will be omitted herein.

An air cleaner 2 for removing dust and the like contained in intake air A is connected to an upstream end of the intake pipe 10. In addition, a downstream end of the intake pipe 10 is connected to a cylinder head of the engine body via an intake manifold (not shown).

Furthermore, as shown in FIGS. 1 and 2, the intake pipe 10 of the present embodiment includes a connection portion 11 to which a blow-by gas pipe 30 described below is connected. Note that the connection portion 11 of the present embodiment is defined as a portion between two-dot chain lines a1 and a2 shown in FIG. 1. In addition, a gas inlet 11a for introducing a blow-by gas B from the blow-by gas pipe 30 thereinto is formed in a central portion of the connection portion 11 in an axial direction.

The turbocharger 20 includes a turbine (not shown) to be driven to rotate by an exhaust gas that flows through the exhaust pipe, and a compressor 21 to be driven to rotate by a rotational force of the turbine. The compressor 21 includes a compressor housing 21a, and a compressor wheel 21b rotatably provided in the compressor housing 21a.

A blow-by gas recirculation device 100 of the internal combustion engine 1 includes the blow-by gas pipe 30 connected to the intake pipe 10 at a position on an upstream side of the compressor 21. The blow-by gas recirculation device 100 further includes an oil separator 40 for separating oil from the blow-by gas B. The oil separator 40 is provided on the blow-by gas pipe 30.

The blow-by gas recirculation device 100 further includes an adsorption/desorption member 30 provided in at least one of the intake pipe 10 and the blow-by gas pipe 30, which are located between the oil separator 40 and the compressor 21. In the present embodiment, the adsorption/desorption member 50 provided in the intake pipe 10 will be described.

The blow-by gas B is a gas leaked into a crankcase from a gap between a piston and a cylinder in the engine body. A blow-by gas passage of the present disclosure includes: a gas passage (not shown) on an engine body side that extends from an inside of the crankcase through a cylinder block and the cylinder head into a head cover; and the blow-by gas pipe 30 connected to a downstream end of the gas passage.

For example, a hose member made of resin is used as the blow-by gas pipe 30. A downstream end of the blow-by gas pipe 30 is connected to lire gas inlet 11a formed at the connection portion 11.

The oil separator 40 is provided in an intermediate portion of the blow-by gas pipe 30. The oil separator 40 includes a casing 41 and a cylindrical filter element 42 accommodated in the casing 41. The oil separator 40 further includes a return pipe 43 for returning separated oil indicated by a black arrow O to the crankcase.

Specifically, the oil separator 40 is configured to introduce the blow-by gas B into the casing 41 from a blow-by gas pipe 30 on the upstream side, and filter the blow-by gas B by the filler element 42, thereby separating the oil. In addition, the oil separator 40 discharges the blow-by gtts B, from which the oil is separated, to a blow-by gas pipe 30 on the downstream side, and further, discharges the separated oil O to the return pipe 43. Note that the filter element 42 of the present embodiment serves to mainly separate oil having a large diameter (for example, about 1 μm), and mainly allow mist-shaped oil having a small particle diameter (for example, about 0.5 μm) to pass through together with the blow-by gas B.

The adsorption/desorption member 50 is configured to adsorb the oil contained in the blow-by gas B that has passed through the oil separator 40, and expand the panicle diameter of the oil 10 desorb the oil.

In addition, the adsorption/desorption member 50 of the present embodiment is provided on an inner circumferential surface 11b of the connection portion 11, which is on a side opposite to a blow-by gas pipe 30 side. Furthermore, though details will be described below, the adsorption/desorption member 50 is provided on the inner circumferential surface 11b at a position with which the blow-by gas B introduced into the connection portion 11 from the blow-by gas pipe 30 may collide.

Additionally, the adsorption/desorption member 50 is formed of a nonwoven fabric. As shown in FIG. 2, the adsorption/desorption member 50 is formed in a semi-cylindrical shape and is laid over a half circumference of the inner circumferential surface 11b on a side opposite to the gas inlet 11a relative to a pipe axis C. Also, the adsorption/desorption member 50 extends on the upstream side and the downstream side of a position of the gas inlet 11a in a pipe axis direction of the connection portion 11.

Next, an operation and an effect of the blow-by gas recirculation device 100 according to the present embodiment will be described.

As shown in FIGS. 1 and 2, during operation of the internal combustion engine 1, the blow-by gas B in the crankcase is recirculated to the intake pipe 10 through the gas passage (not shown) on the engine body side, and the bow-by gas pipe 30.

Here, caulking abnormality may occur in the compressor 21 due to the oil mixed in the blow-by gas B recirculated to the intake pipe 10.

That is, on the upstream side of the compressor 21, the oil still has a low temperature of about room temperature, and is a liquid having a relatively low viscosity. However, when the intake air A in which the oil is mixed is compressed by the compressor 21 and is subjected to temperature rise and pressure increase, the oil contained in the intake air A is also heated to reach a high temperature (about 160° C. to 170° C.) and is denatured to a relatively high-viscosity liquid. Then, the high-viscosity oil adheres to sliding portions of the compressor housing 21a and the compressor wheel 21b, and thus, sliding resistance is increased. Further, the high-viscosity oil adheres to a compressor outlet passage on the downstream side of the compressor wheel 21b, and partially closes the passage.

In this way, the adhesion of the high-viscosity oil to various locations is referred to as caulking, and abnormality of the compressor 21 caused by the caulking is referred to as caulking abnormality. Then, when the caulking abnormality occurs, there is a possibility that an original performance of the compressor 21 cannot be exhibited.

In contrast, the oil O having a large particle diameter (for example, about 1 μm) can be mainly separated from the blow-by gas B in such a manner that the oil separator 40 is provided on the blow-by gas pipe 30 in the present embodiment. However, a mist-shaped oil (not shown) having a small particle diameter (for example, about 0.5 μm) is not separated by the oil separator 40, and mainly passes therethrough.

In addition, for the oil contained in the blow-by gas B, the smaller the particle diameter is, the larger a ratio of the surface area to the mass is. Thus, the oil may be easily thermally denatured by the heat of the compressor 21. Therefore, the oil having a small panicle diameter that is not separated by the oil separator 40 and passes therethrough is more likely to cause the caulking abnormality than the oil having a large particle diameter that is separated by the oil separator 40.

Therefore, as indicated by reference symbols D in the drawing, the adsorption desorption member 50 adsorbs the oil contained in the blow-by gas B that has passed through the oil separator 40, and desorbs the oil in a manner of expanding the particle diameter of the oil in the present embodiment.

That is, the adsorption/desorption member 50 adsorbs the oil having a small panicle diameter that is not separated by the oil separator 40 and passes therethrough, and collects the oil to thereby expand the particle diameter. Then, oil D having an expanded particle diameter exceeds an adsorption allowable amount of the adsorption/desorption member 50 and exudes to fall under its own weight, or scatters to the downstream side by the intake air A and the blow-by gas B. As a result, the oil D having a large particle diameter can be desorbed from the adsorption/desorption member 50.

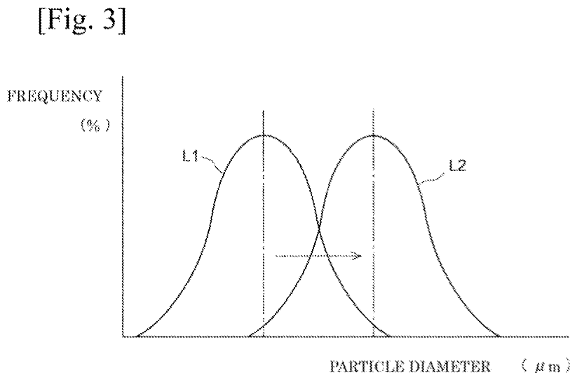

FIG. 3 is a graph schematically showing a particle diameter distribution of the oil contained in the blow-by gas B. A vertical axis indicates a frequency (%) that represents the number of particles of oil in the intake pipe 10 directly upstream of the compressor 21 as an existence ratio, and a horizontal axis indicates a particle diameter (μm) of that oil. In addition, a curve L1 is a particle diameter distribution curve of oil when the adsorption/desorption member 50 is not provided, and a curve L2 is a panicle diameter distribution curve of oil in the present embodiment in which the adsorption/desorption member 50 is provided.

As can be seen from a comparison between the curve L1 and the curve L2 in FIG. 3, an amount of oil having a small particle diameter is reduced and an amount of oil having a large particle diameter is increased by the expansion of the particle diameter of oil in the present embodiment in which the adsorption/desorption member 50 is provided, as compared with the case where the adsorption/desorplion member 50 is not provided. In this way, the oil whose particle diameter has been expanded has a smaller ratio of the surface area to the mass as compared with the oil whose particle diameter has not been expanded, so that the oil with expanded particle diameter is less likely to be thermally denatured by the heat of the compressor 21.

Therefore, occurrence of the caulking abnormality of the compressor 21 due to the oil contained in the blow-by gas B that has passed through the oil separator 40 can be prevented by virtue of the blow-by gas recirculation device 100 according to the present embodiment.

Additionally, in the connection portion 11 of the intake pipe 10, the adsorption desorption member 50 of the present embodiment is provided on the inner circumferential surface 11b on the side opposite to the blow-by gas pipe 30 side.

Here, as a comparative example, it is assumed that the adsorption/desorption member 50 is provided on an inner circumferential surface of a straight part of the intake pipe 10 or the blow-by gas pipe 30. In this case, the oil comained in the blow-by gas B flows together with the blow-by gas B in a pipe axis direction, and simply passes through the adsorption desorption member 50. Therefore, the adsorption/desorption member 50 cannot sufficiently adsorb the oil in the comparative example.

In contrast, in the present embodiment, a flow direction of the blow-by gas B introduced into the connection portion 11 from the blow-by gas pipe 30 is bent toward the downstream side of the intake pipe 10. Therefore, the oil contained in the blow-by gas B does not completely bend due to an inertial force, and collides with the adsorption/desorption member 50 on an outer corner side. Therefore, the adsorption/desorption member 50 can efficiently and reliably adsorb the oil contained in the blow-by gas B.

Additionally, the adsorption/desorption member 50 is formed of a nonwoven fabric. Therefore, the adsorption/desorption member 50 can be simply provided only when a nonwoven fabric is attached to the inner circumferential surface 11b of the connection portion 11.

On the other hand, the basic embodiment described above can be provided as the following modifications. In the following description, the same components as those of the above-described embodiment are denoted by the same reference numerals, and detailed descriptions thereof will be omitted. A reference numeral 50′ or 50″ is used for the adsorption/desorption member in each modification.

### First Modification

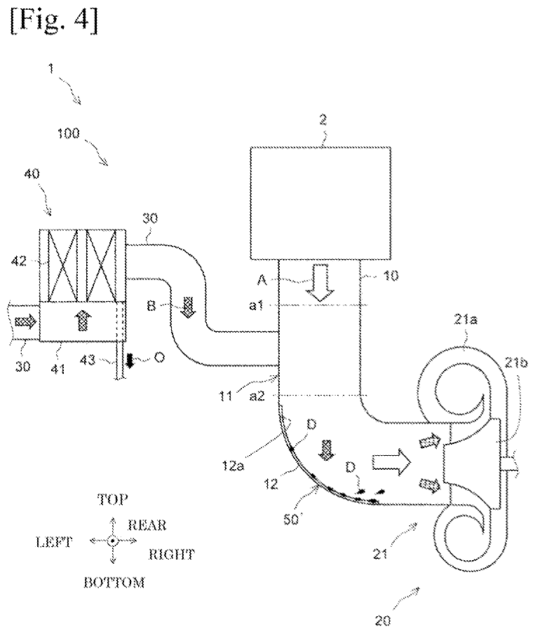

As shown in FIG. 4, a bent portion 12 may be formed in the intake pipe 10, and an adsorption/desorption member 50′ may be provided on an inner circumferential surface 12a on an outer corner side of the bent portion 12 of the intake pipe 10. In the example shown in the drawing, the bent portion 12 of the intake pipe 10 forms a part that is bent at an angle of 90° in a right direction from a position of a downstream end of the connection portion 11. The bent portion 12 may be bent at an angle other than 90°.

Although not shown, the adsorption desorption member 50′ of the first modification is laid over a half circumference of the inner circumferential surface 12a on the outer corner side of the bent portion 12 of the intake pipe 10. Additionally, the adsorption/desorption member 50′ is provided over the entire length of the bent portion 12 in the pipe axis direction.

In the case of the first modification, a flow direction of the blow-by gas B is bent at the bent portion 12 of the intake pipe 10, so that the oil contained in the blow-by gas B does not completely bend due to an inertial force, and collides with the adsorption/desorption member 50′.

Therefore, by virtue of the first modification, the adsorption/desorption member 50′ can efficiently adsorb the oil contained in the blow-by gas B in the same manner as in the above-described basic embodiment.

### Second Modification

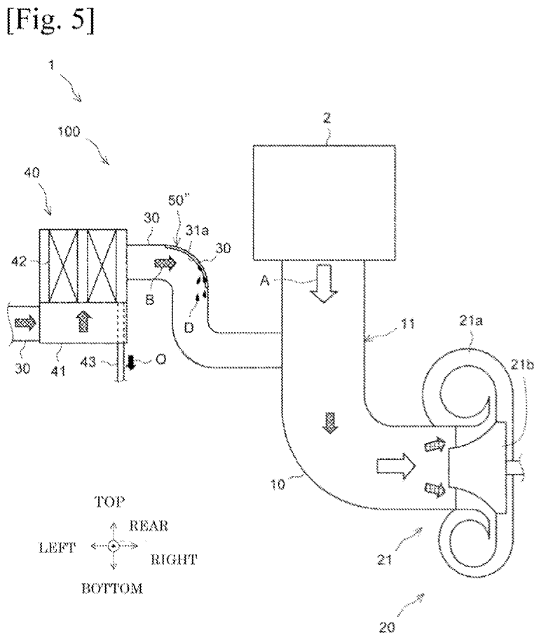

As shown in FIG. 5, an adsorption/desorpuon member 50″ may be provided in the blow-by gas pipe 30. In addition, a bent portion 31 may be formed in the blow-by gas pipe 30, and the adsorption/desorption member 50″ may be provided on an inner circumferential surface 31a on the outer corner side of the bent portion 31 of the blow-by gas pipe 30. Note that in the example shown in the drawing, the bent portion 31 of the blow-by gas pipe 30 is defined as a part that extends in the rigid direction from an outlet side of the oil separator 40 and that is bent downward at an angle of 90°. Additionally, the bent portion 31 may be bent at an angle other than 90°.

Although not shown, the adsorption/desorption member 50″ of the second modification is laid over a half circumference of the inner circumferential surface 31a on the outer corner side of the bent portion 31 of the blow-by gas pipe 30. The adsorption/desorption member 50″ is also provided over the entire length of the bent portion 31 in the pipe axis direction.

According to the second modification, the oil contained in the blow-by gas B that has passed through the oil separator 40 can be adsorbed to the adsorption/desorption member 50″ in the blow-by gas pipe 30, and the particle diameter of the oil can be expanded, so that the oil can be desorbed.

In addition, the oil contained in the blow-by gas B collides with the adsorption/desorption member 50″ and can be efficiently and reliably adsorbed in such a manner that the adsorption/desorption member 50″ is provided on the inner circumferential surface 31a on the outer corner side of the bent portion 31 of the blow-by gas pipe 30.

### Third Modification

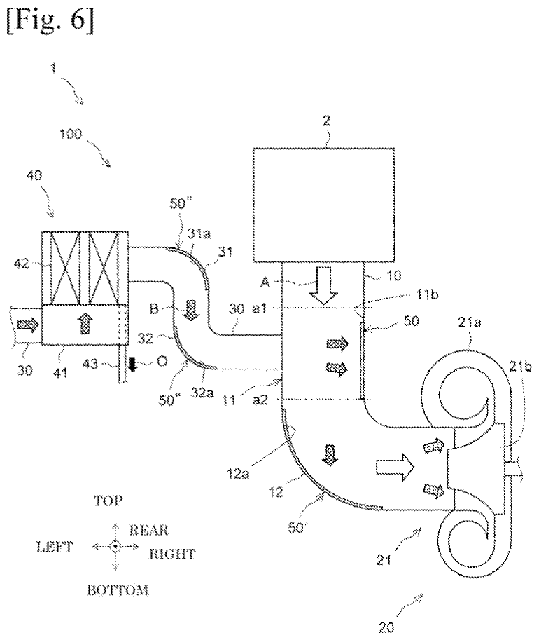

As shown in FIG. 6, a plurality of adsorption desorption members 50, 50′, 50″ may-be provided in combination with the above-described basic embodiment and the first and second modifications.

In addition, the adsorption/desorption members 50, 50′, 50″ may be provided at any position as long as the position is located between the oil separator 40 and the compressor 21. For example, as shown in FIG. 6, a bent portion 32 may be provided in the blow-by gas pipe 30 on the downstream side of the bent portion 31 shown in the second modification, and the adsorplion desorption member 50″ may be provided on an inner circumferential surface 32a on the outer corner side of the bent portion 32.

### Fourth Modification

The adsorption/desorption members 50, 50′, 50″ are not limited to the nonwoven fabric, and can be formed of any material. For example, a filter formed of a porous material, or a material such as a sponge, a net, a woven fabric, or a felt may be used for the adsorption/desorption members 50, 50′, 50″.

### Fifth Modification

Although not shown, the adsorption/desorption members may be laid over, for example, entire circumferences of the inner circumferential surfaces of the bent portions 12, 31, 32 described above. Additionally, the adsorption/desorption members may be provided on an inner circumferential surface of a straight part of the intake pipe 10 or the blow-by gas pipe 30.

The present application is based on Japanese Patent Application (No. 2018-132235) filed on Jul. 12, 2018, contents of which are incorporated herein as reference.

### INDUSTRIAL APPLICABILITY

The present disclosure is useful in achieving effects capable of preventing caulking abnormality of a compressor due to oil contained in a blow-by gas that has passed through an oil separator, and being applied to an internal combustion engine such as a turbocharged internal combustion engine.

### REFERENCE SIGNS LIST

1 Internal combustion engine

10 Intake pipe (intake passage)

11 Connection portion

20 Turbocharger

21 Compressor

30 Blow-by gas pipe (blow-by gas passage)

40 Oil separator

50 Adsorption/desorption member

100 Blow-by gas recirculation device

A Intake air

B Blow-by gas

D Oil with expanded particle diameter

O Oil separated by oil separator

1. A blow-by gas recirculation device for an internal combustion engine that includes an intake passage and a compressor of a turbocharger provided in the intake passage, the blow-by gas recirculation device comprising:
a blow-by gas passage that is connected to the intake passage at a position on an upstream side of the compressor;
an oil separator, provided in the blow-by gas passage, for separating oil from a blow-by gas; and
an adsorption/desorption member that is provided in at least one of the blow-by gas passage and the intake passage located between the oil separator and the compressor, and that is configured to adsorb oil contained in a blow-by gas that has passed through the oil separator, and expand a particle diameter of the oil to desorb the oil.

2. The blow-by gas recirculation device according to claim 1,
wherein the intake passage includes a connection portion to which the blow-by gas passage is connected, and
the adsorption/desorption member is provided on an inner circumferential surface of the connection portion that is located on a side opposite to a blow-by gas passage side.

3. The blow-by gas recirculation device according to claim 1,
wherein a bent portion is formed on at least one of the intake passage and the blow-by gas passage, and
the adsorption/desorption member is provided on an inner circumferential surface on an outer corner side of the bent portion.

4. The blow-by gas recirculation device according to claim 1,
wherein the adsorption/desorption member is formed of a nonwoven fabric.
